(19) United States
(12) Patent Application Publication
(10) Pub. No.: US 2026/0014909 A1
(43) Pub. Date: Jan. 15, 2026

(54) HEADREST ADJUSTMENT DEVICE FOR INTEGRAL VEHICLE SEAT

(71) Applicants: Hyundai Motor Company, Seoul (KR); Kia Corporation, Seoul (KR)

(72) Inventors: Jiaping Xia, Yantai (CN); Kai Shang, Yantai (CN); Jihyun Kim, Hwaseong-Si (KR); Xin Li, Yantai (CN)

(73) Assignees: Hyundai Motor Company, Seoul (KR); Kia Corporation, Seoul (KR)

(21) Appl. No.: 19/207,015

(22) Filed: May 13, 2025

(30) Foreign Application Priority Data
Jul. 10, 2024 (CN) 202410927358.2

(51) Int. Cl. B60N 2/815; B60N 2/818; B60N 2/865

(52) U.S. Cl. CPC B60N 2/815; B60N 2/818; B60N 2/865

(57) ABSTRACT

A headrest adjustment device for an integral vehicle seat for adjusting a position of a headrest in a forward and backward direction or an up and down direction, includes a headrest support, a locking/unlocking device, an operating rod, a latch plate, a pad connecting portion, a front and rear guide member, a front and rear locking pin, a locking pin spring, two guide rod sleeves, two guide rods, and a stopper. When a button is pressed in a locked state, the locking guide plate moves to one side to be in an unlocked state and maintains the unlocked state, when the button is pressed again, the locking guide plate returns from the unlocked state to an initial position, and the locking pin spring pushes the front and rear locking pin to the other side to return to a locked position thereof.

### CROSS-REFERENCE TO RELATED APPLICATION

The present application claims priority to Chinese Patent Application No. 202410927358.2 filed with the Chinese Intellectual Property Office on Jul. 10, 2024, the entire contents of which is incorporated herein for all purposes by this reference.

### BACKGROUND OF THE PRESENT DISCLOSURE

### Field of the Present Disclosure

The present disclosure relates to a headrest of a vehicle seat, and more particularly, to a headrest adjustment device for an integral vehicle seat.

### Description of Related Art

A conventional vehicle seat generally has a separate design in which a headrest and a seat itself are separated, and a headrest guide rod is exposed, which is visually poor and unsafe.

To adjust a position of the headrest, the headrest should be locked or unlocked by a locking/unlocking device.

The locking/unlocking device of the related art is easily damaged because the locking/unlocking device moves along the headrest, and the headrest does not have a simple structure overall.

The locking/unlocking device of the related art described above requires that a button of the locking/unlocking device should be continuously pressed during adjusting the headrest. Therefore, manipulation is difficult and takes a lot of time.

The above information included in this Background Art is only for enhancement of understanding of the background of the present disclosure and therefore it may contain information that does not form the related art that is already known in this country to a person of ordinary skill in the art.

### BRIEF SUMMARY

Various aspects of the present disclosure are directed to providing a headrest adjustment device for an integral vehicle seat configured for adjusting a position of a headrest in a forward and backward direction and an up and down direction, in which the headrest and a seat backrest are more integrated and aesthetically pleasing, and a locking/unlocking device is simple to manipulate, stable, and not easily damaged.

According to an exemplary embodiment of the present disclosure, a headrest adjustment device for an integral vehicle seat for adjusting a position of a headrest in a forward and backward direction or an up and down direction is provided. The adjustment device may include a headrest support, a pad connecting portion, a front and rear guide member, a guide rod, and a guide rod sleeve.

The headrest support may be fixedly disposed on a lower end portion of the headrest, and at least one end portion of the headrest support may be provided with a guide rod through hole.

The pad connecting portion may be fixedly disposed on a pad of the headrest.

The front and rear guide member may be mounted to the pad connecting portion and guide the pad connecting portion to move in the forward and backward direction thereof.

The guide rod may include a lower end portion fixedly connected to a backrest frame of the seat.

The guide rod sleeve may be sleeved to the guide rod and moves up or down with respect to the guide rod.

The guide rod sleeve and the front and rear guide member may be fixedly disposed on the headrest support.

The headrest adjustment device for an integral vehicle seat may further include an operating rod, a latch plate, and a locking/unlocking device, in which the operating rod may be provided with two legs extending downward, the two legs being parallel to each other, and a leg slot extending upward and downward may be provided on one side of one leg and one side of the other leg adjacent to each other.

The latch plate hole may be provided on at least one end portion of the latch plate, respectively, a latch may be provided on one edge portion of the latch plate hole, and an upper end portion of the operating rod may be connected to the other end portion of the latch plate.

The locking/unlocking device may include a button, a locking guide plate, and an unlocking plate fixed to the locking guide plate, and both sides of the unlocking plate may be inserted into the leg slot so that the operating rod moves up or down with respect to the unlocking plate.

The guide rod may be provided with a plurality of latch grooves along a longitudinal direction, a state in which the latch is engaged and inserted into the latch groove may be a locked state, the latch may be in an unlocked state when the latch is disengaged from the latch groove, when a button is pressed to one side in the locked state, an unlocking operation may be performed, the locking guide plate may move to the one side and move the operating rod to push the latch plate to the one side and disengage the latch from the latch groove, and at the same time, the locking guide plate may maintain an unlocked state position, when the button is pressed to the one side again, a locking operation may be performed, and the locking guide plate may return to an initial position in the unlocked state, and the operating rod may move to push the latch plate to the one side to engage and insert the latch into the latch groove.

The headrest adjustment device for an integral vehicle seat may further include front and rear locking pins and a locking pin spring, in which the front and rear locking pin may be connected to the latch plate, the locking pin spring may be provided between the headrest support and the front and rear locking pins, and the pad connecting portion may be provided with an engaging groove, and by performing the unlocking operation, the front and rear locking pins may overcome an elastic force of the locking pin spring and be disengaged from the engaging groove, and by performing the locking operation, the front and rear locking pins may be pushed and inserted into the engaging groove of the pad connecting portion by a restoring force of the locking pin spring.

The headrest support may further include a pin spring support body and a base spring groove, the pin spring support body may protrudes upwards from one end wall of the base spring groove, the latch plate may be provided with a spring seat hole, the spring seat hole may be aligned with the base spring groove, the pin spring support body may be in close contact with one end wall of the spring seat hole, the front and rear locking pin may be further provided with a locking pin projection protruding downward, the locking pin projection may be in close contact with the other end wall of the spring seat hole, and the locking pin spring may be provided between the pin spring support body and the locking pin projection.

The headrest adjustment device for an integral vehicle seat may further include a second locking pin spring, the headrest support may further include a second pin spring support body and a second base spring groove, the second pin spring support body may protrude upwards from one end wall of the second base spring groove, the latch plate may include a second spring seat hole, the second spring seat hole may be aligned with the second base spring groove, the second pin spring support body may come into close contact with one end wall of the second spring seat hole, and the second locking pin spring may be provided between the second pin spring support body and the other end wall of the second spring seat hole.

The locking/unlocking device may further include a button rod, a locking cable, a return spring, and a locking frame, in which the locking frame may be fixed to a seat backrest frame, one end portion of the return spring may be connected to the locking guide plate and the other end portion may be connected to the locking frame, the button may be connected to the locking guide plate through the button rod, the locking guide plate includes a cable groove, the locking cable may extend within the cable groove, one end portion of the locking cable may be fixed to the locking frame, and the other end portion of the locking cable may be provided with a cable hook.

The cable groove may include a main groove and a sealed annular groove, one end portion of the sealed annular groove may be a connecting end portion communicating with the main groove, the other end portion may be formed as a V-shaped groove, and a V-shaped upper end portion of the V-shaped groove may face the main groove.

When the button is pressed for the first time, the locking guide plate may move so that the cable hook enters the V-shaped groove from the main groove and is fixed.

When the button is pressed again, the cable hook may be disengaged from the V-shaped groove and return to the main groove, and the locking guide plate may return to the initial position by the action of the return spring.

The sealed annular groove may further include a straight groove portion and a branch groove, the straight groove portion may extend from an end portion of the main groove to one end portion of the V-shaped groove, the branch groove may branch off from a connection point between the straight groove portion and the main groove and extend to the other end portion of the V-shaped groove, the other end portion of a V-shaped internal wall of the V-shaped groove may be formed as a guide mouth, and the guide mouth may be disposed closer to the branch groove, so that a width of one side of the branch groove of the V-shaped groove is smaller than that of one side of the straight groove portion.

The connection end portion of the sealed annular groove may be connected to one end portion of the V-shaped groove through the straight groove portion, and may be connected to the other end portion of the V-shaped groove through the branch groove, and a straight groove step may be formed between the straight groove portion and the main groove, so that a depth of the straight groove portion is shallower than a depth of the main groove, and a branch step may be formed at a connecting portion of the branch groove and the V-shaped groove, so that a depth of the branch groove is shallower than a depth of the V-shaped groove.

The straight groove portion may be provided with a ramp starting point near to the V-shaped groove, and the depth of the straight groove portion may be gradually shallow from the ramp starting point to the straight groove step.

The front and rear guide members may be provided with a rolling bearing for guiding the pad connecting portion.

Another exemplary embodiment of the present disclosure, there is further provided the integral vehicle seat including the headrest adjustment device for the integral vehicle seat. The integral vehicle seat may further include a backrest cushion, a headrest groove may be provided on an upper portion of the backrest cushion, an opening may be provided on an upper portion of the headrest groove, the backrest cushion may be fixedly disposed on a backrest frame, and the headrest may be positioned within the headrest groove.

The headrest adjustment device for the integral vehicle seat according to an exemplary embodiment of the present disclosure may realize the following technical effects.

Simply pressing the button of the locking/unlocking device can allow the switching between the locked state and the unlocked state, and the position of the headrest may be adjusted in the forward and backward direction and the up and down direction in the unlocked state. The headrest is provided within the headrest groove of the backrest cushion of the integral vehicle seat, so that the headrest guide rod is always hidden, which is visually more pleasing. The locking/unlocking device is provided in the frame of the backrest of the integral vehicle seat and does not move along the headrest, so the locking/unlocking device is not easily damaged, has a more compact structure overall, and is pleasing to the eye.

It should be understood that the terms “vehicle”, “vehicular” or other similar terms used in the present specification generally include a motorized vehicle such as a passenger vehicle, including a sports utility vehicle (SUV), a bus, a truck, and various commercial vehicles, a ship including various boats and ships, aircraft, and the like, and also include hybrid vehicles, electric vehicles, plug-in hybrid electric vehicles, hydrogen-powered vehicles, and other alternative fuel (such as fuel derived from sources other than petroleum) vehicles.

The method and device of the present disclosure have other features and advantages, which are apparent from the accompanying drawings and the specific embodiments described below, or will be described in detail in the accompanying drawings and the specific embodiments described below, all of which are intended to describe certain principles of the present disclosure.

### BRIEF DESCRIPTION OF THE DRAWINGS

FIG. 1 is a schematic diagram illustrating a combination of main components of a headrest adjustment device according to an exemplary embodiment of the present disclosure.

FIG. 2 is a partial schematic diagram of a headrest adjustment device according to an exemplary embodiment of the present disclosure, and illustrates a mounting relationship between a locking/unlocking device, an operating rod, and a headrest support.

FIG. 3 is a diagram illustrating details of portion B of FIG. 2, and illustrates a mounting relationship between a locking/unlocking device and an operating rod.

FIG. 4 is a diagram illustrating a headrest support of a headrest adjustment device according to an exemplary embodiment of the present disclosure.

FIG. 5A is a schematic diagram illustrating a locking/unlocking device of a headrest adjustment device according to an exemplary embodiment of the present disclosure.

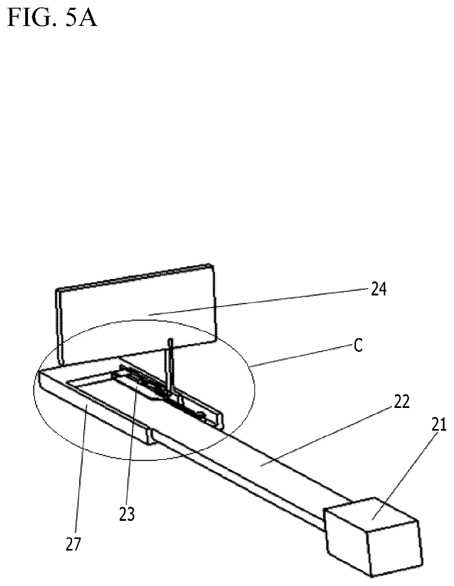

FIG. 5B is a diagram illustrating details of portion C of FIG. 5A, and does not illustrate an unlocking plate for clarity.

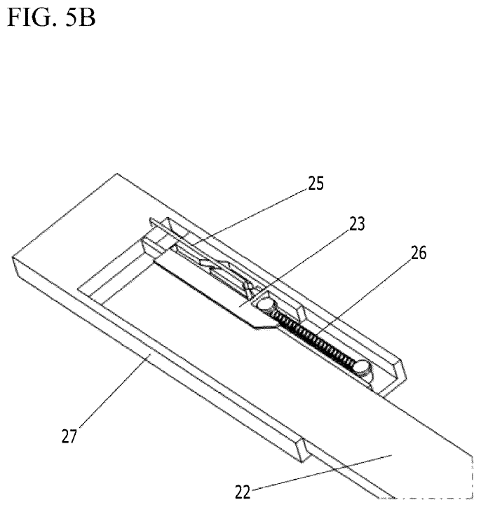

FIG. 5C is a diagram illustrating details of a cable groove of a locking guide plate of a locking/unlocking device of a headrest adjustment device according to an exemplary embodiment of the present disclosure.

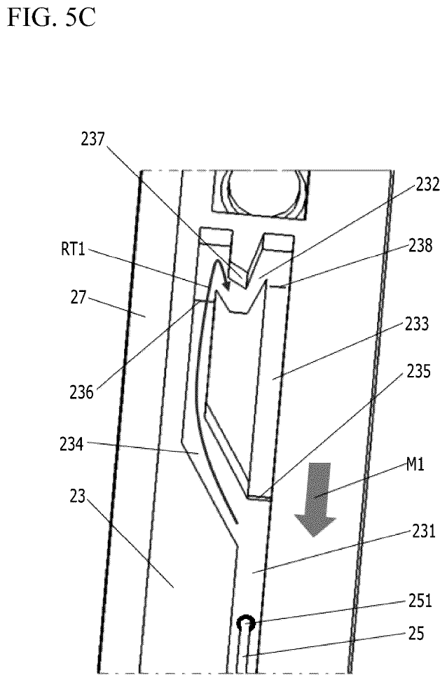

FIG. 6 is a diagram illustrating an operating rod of a headrest adjustment device according to an exemplary embodiment of the present disclosure.

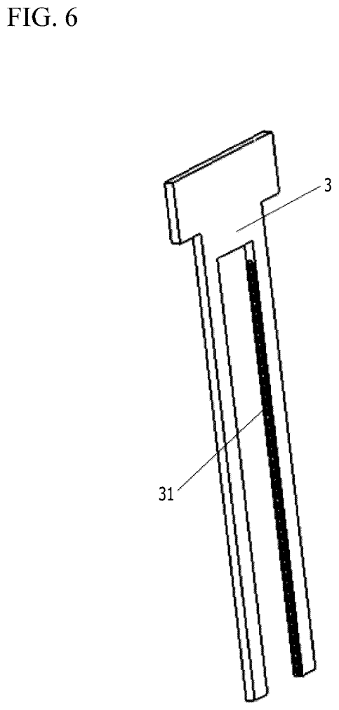

FIG. 7 is a diagram illustrating a latch plate of a headrest adjustment device according to an exemplary embodiment of the present disclosure.

FIG. 8 is an exploded perspective view exemplarily illustrating a front and rear adjustment assembly of a headrest adjustment device according to an exemplary embodiment of the present disclosure.

FIG. 9 is a diagram illustrating a mounting position of a front and rear locking pin of a headrest adjustment device according to an exemplary embodiment of the present disclosure.

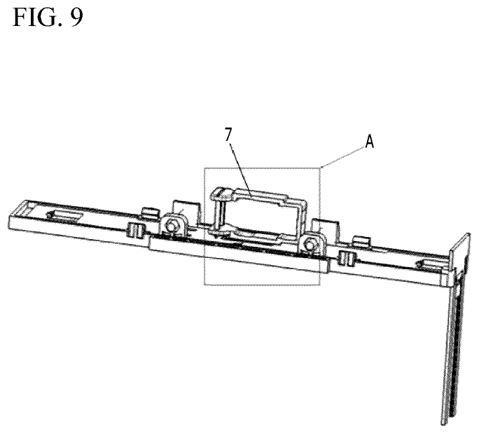

FIG. 10 is a partial enlarged view of portion A of FIG. 9, and illustrates assembly relationship between a headrest support, a latch plate, a front and rear locking pin, and a locking pin spring of a headrest adjustment device according to an exemplary embodiment of the present disclosure.

FIG. 11A is a schematic diagram illustrating that a headrest adjustment device according to an exemplary embodiment of the present disclosure is mounted on a seat backrest.

FIG. 11B is a schematic diagram illustrating an upper portion of a seat provided with a headrest adjustment device according to an exemplary embodiment of the present disclosure.

It should be understood that the drawings are simplified representations of each feature to describe the basic principles of the present disclosure, and are not necessarily drawn to scale. Specific design features included in the present disclosure (including, for example, specific sizes, directions, positions, and shapes) are partially determined according to specific purpose applications and usage environments.

The same reference numbers throughout the drawings indicate identical or equivalent elements of the present disclosure.

### DETAILED DESCRIPTION

Hereinafter, various exemplary embodiments of the present disclosure will be described in more detail with reference to the appended drawings. The exemplary embodiments described above are only examples and may be implemented in various forms by those skilled in the art. Therefore, the present disclosure is not limited to the exemplary embodiments described in the present specification.

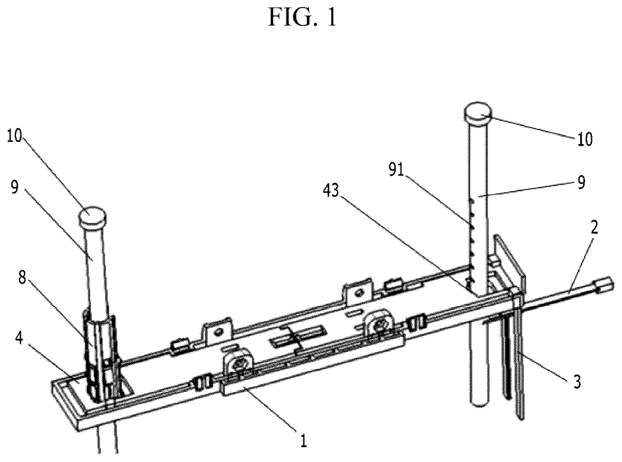

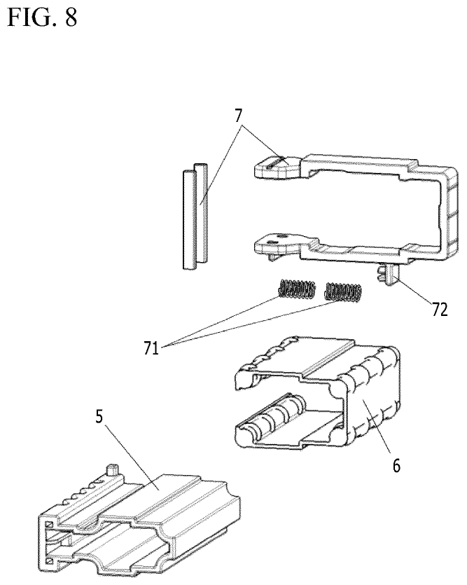

FIG. 1 is a schematic diagram illustrating a combination of main components of a headrest adjustment device according to an exemplary embodiment of the present disclosure. To illustrate details, a front and rear adjustment assembly is omitted in FIG. 1. The front and rear adjustment assembly include a pad connecting portion 5, a front and rear guide member 6, a front and rear locking pin 7, and a locking pin spring 71 (see FIG. 8). FIG. 1 illustrates a latch groove 91 of a guide rod 9 by removing a right guide rod sleeve 8.

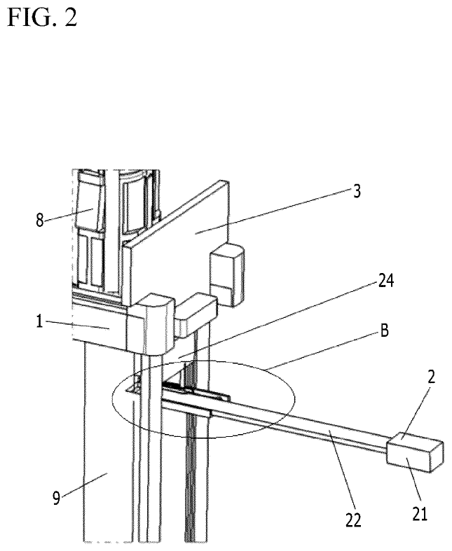

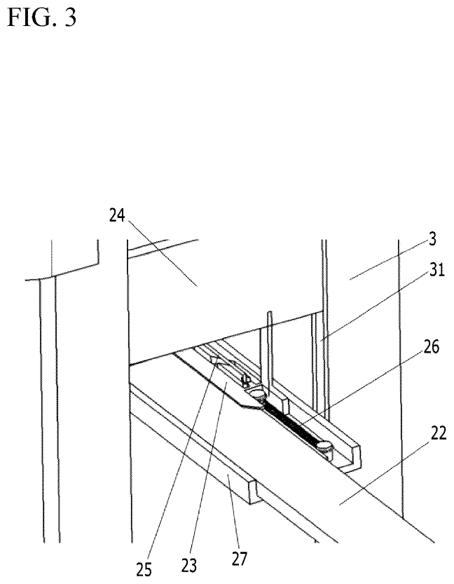

FIG. 2 is a partial schematic diagram of the headrest adjustment device according to an exemplary embodiment of the present disclosure, and illustrates a mounting relationship between a locking/unlocking device, an operating rod, and a headrest support. FIG. 3 is a diagram illustrating details of portion B of FIG. 2, and illustrates a mounting relationship between the locking/unlocking device and the operating rod.

As illustrated in FIG. 2 and FIG. 3, an unlocking plate 24 of the locking/unlocking device 2 is inserted into a leg slot 31 of two legs of the operating rod 3, so that the operating rod 3 may move up or down with respect to the unlocking plate 24. An upper portion of the operating rod 3 is mounted on the headrest support 1. For example, in the drawings, the upper portion of the operating rod 3 is snap-connected to/operatively connected to the headrest support 1.

The headrest support 1 is mounted to an internal lower portion of the headrest to support the headrest and move up or down together with the headrest.

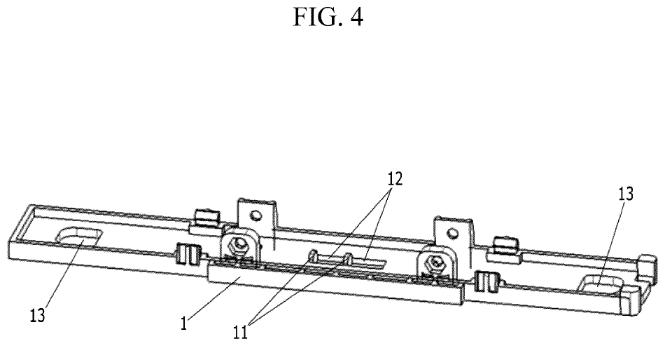

FIG. 4 is a diagram illustrating the headrest support of the headrest adjustment device according to an exemplary embodiment of the present disclosure. As illustrated in FIG. 4, a middle portion of the headrest support 1 includes two pin spring support bodies 11 and two base spring grooves 12 for mounting springs, and each guide rod through hole 13 is provided on each end portion. The guide rod through hole 13 is generally a rectangular in shape, and a long side of the rectangle extends in a longitudinal direction of the headrest support 1.

The locking/unlocking device 2 is fixed to a seat backrest. By pressing the locking/unlocking device 2, the operating rod 3 may be moved, so a latch plate 4 may be moved. When the locking/unlocking device 2 is pressed for the first time, the latch plate 4 moves to the left in the drawings and is unlocked, and the headrest may be adjusted in the present state. When the locking/unlocking device 2 is pressed again, the latch plate 4 returns and the headrest is locked.

The lower portion of the operating rod 3 is connected to a nut plate of the locking/unlocking device 2 (connected by a bolt), and the upper portion is connected to the latch plate 4. The operating rod 3 may move together with the headrest.

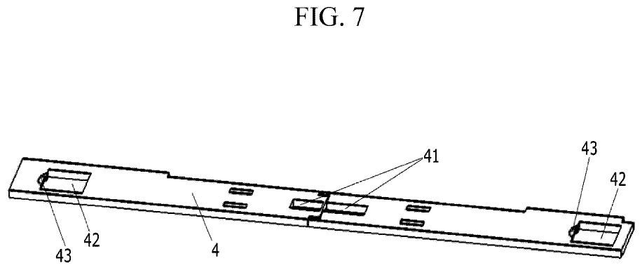

FIG. 7 illustrates the latch plate 4 of the headrest adjustment device according to an exemplary embodiment of the present disclosure. As illustrated in FIG. 7, two spring seat holes 41 are disposed in the middle portion of the latch plate 4, each latch plate hole 42 is disposed at each end portion, and a latch 43 is formed on a left edge portion of the latch plate hole 42. As the operating rod 3 moves, the latch plate 4 is pushed or pulled to unlock or lock an up and down adjustment function and a front and rear adjustment function of the headrest.

FIG. 8 is an exploded perspective view exemplarily illustrating the front and rear adjustment assembly of the headrest adjustment device according to an exemplary embodiment of the present disclosure. The front and rear adjustment assembly include the pad connecting portion 5, the front and rear guide member 6, the front and rear locking pin 7, and the locking pin spring 71. The front and rear locking pin 7 includes a locking pin projection 72 protruding downward. In the drawings, the front and rear locking pin 7 includes a C-shaped member and a cylindrical member mounted to each other.

The pad connecting portion 5 is assembled with a front pad and a rear pad of the headrest through front and rear surfaces of the pad connection portion 5. When the front and rear locking pin 7 is unlocked, the pad connecting portion 5 moves forward or backward together with the headrest.

The front and rear guide member 6 is assembled on an external surface of the pad connecting portion 5. The front and rear guide member 6 includes a rolling bearing on an internal surface of the front and rear guide member 6, so that the headrest moves forward or backward through the pad connecting portion 5 disposed inside the front and rear guide member 6.

The front and rear locking pin 7 is assembled on an external surface of the front and rear guide member 6, so that the front and rear locking pin 7 may move in left or right direction with respect to the front and rear guide member 6, but the front and rear locking pin 7 and the front and rear guide member 6 cannot move relatively in the forward or the rear direction thereof. In the locked state, the front and rear locking pin 7 is locked to the pad connecting portion 5, and the pad connecting portion 5 may not move with respect to the front and rear guide member 6. When the latch plate 4 is pushed to one side, the front and rear locking pin 7 is also pushed together and disengaged from the pad connecting portion 5, and the pad connecting portion 5 may move with respect to the front and rear guide member 6, so that the headrest may move forward or backward thereof.

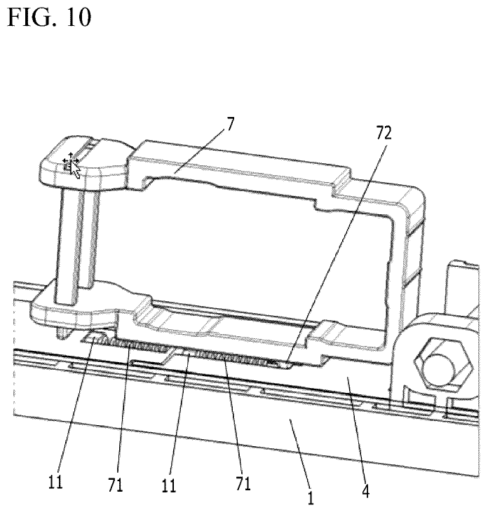

FIG. 10 illustrates an assembly relationship between the headrest support, the latch plate, the front and rear locking pin, and the locking pin spring of the headrest adjustment device according to an exemplary embodiment of the present disclosure.

As illustrated in FIG. 10, in an assembled state, the two pin spring support bodies 11 of the headrest support 1 penetrate through the two spring seat holes 41 of the latch plate 4, respectively, and the two locking pin springs 71 are mounted in the two spring seat holes 41 and the two base spring grooves 12. One end portion of each of the two locking pin springs 71 is in close contact with one pin spring support body 11, and the other end portion of each of the two locking pin springs 71 is in close contact with the locking pin projection 72 of the front and rear locking pin 7 or in close contact with an end wall of one spring seat hole 41. Using the two pin spring support bodies 11 and the two base spring grooves 12 helps reduce a required spring elasticity, resulting in better force balance and smoother movement.

FIG. 10 illustrates the two pin spring support bodies 11 and the two base the spring grooves 12, but it is also possible to use only one pin spring support body and one base spring groove. In the instant case, the pin spring support body 11 protrudes upwards from a left end wall of the base spring groove 12, the latch plate 4 includes the spring seat hole 41 through which the spring seat hole 41 is aligned with the base spring groove 12. The pin spring support body 11 protruding upward is in close contact with a left end wall of the spring seat hole 41. The front and rear locking pin 7 may be further provided with the locking pin projection 72 protruding downward, the locking pin projection 72 may be in close contact with a right end wall of the spring seat hole 41, and the locking pin spring 71 may be provided between the pin spring support body 11 and the locking pin projection 72.

In the case where the two pin spring support bodies 11 and the two base spring grooves 12 are provided, an additional locking pin spring 71 is provided, and the headrest support 1 further includes an additional pin spring support body 11 and an additional base spring groove 12. The additional pin spring support body 11 protrudes upwards from a left end wall of the additional base spring groove 12, the latch plate 4 includes the additional spring seat hole 41, and the additional spring seat hole 41 is aligned with the additional base spring groove 12. The additional pin spring support body 11 is pressed against a left end wall of the additional spring seat hole 41, and the additional locking pin spring 71 is provided between the additional pin spring support body 11 and a right end wall of the additional spring seat hole 41.

The guide rod sleeve 8 is fixedly connected to the headrest support 1 and the latch plate 4, and is used for moving the headrest up or down.

The guide rod 9 is fixedly connected to a backrest frame of a seat (for example, by welding). The guide rod sleeve 8 may move up or down with respect to the guide rod 9. As illustrated in FIG. 1, the guide rod 9 includes the latch groove 91 for locking, and the latch groove 91 is coupled with the latch 43 to implement the locking or the unlocking of the guide rod sleeve 8. To illustrate the latch groove 91, the guide rod sleeve 8 on the right guide rod 9 is omitted in FIG. 1.

A stopper 10 is fixedly connected to an upper end portion of the guide rod 9 (for example, by welding), and may prevent the guide rod sleeve 8 from disengaging from the upper end portion of the guide rod 9.

The locking/unlocking device 2 includes a button 21, a button rod 22, a locking guide plate 23, an unlocking plate 24, a locking cable 25, a return spring 26, and a locking frame 27. The locking frame 27 is fixed to the backrest frame of the seat. One end portion of the return spring 26 is connected to the locking guide plate 23, and the other end portion is connected to the locking frame 27.

The button 21 is provided at one end portion of the button rod 22, and the button rod 22 is connected to the locking guide plate 23. When the button 21 is pressed, the button rod 22 moves to the left, and the locking guide plate 23 also moves with respect to the locking frame 27. Since the unlocking plate 24 is connected to the locking guide plate 23, the unlocking plate 24 moves together with the locking guide plate 23.

The locking guide plate 23 includes a cable groove, and the cable groove includes a main groove 231 and a sealed annular groove. One end portion of the sealed annular groove is a connecting end portion communicating with the main groove 231, and the other end portion thereof is formed as a V-shaped groove 232. A V-shaped upper direction of the V-shaped groove 232 faces the main groove 231. The connecting end portion of the sealed annular groove is connected to one end portion of the V-shaped groove 232 through a straight groove portion 233, and to the other end portion of the V-shaped groove 232 through a branch groove 234.

The straight groove portion 233 is an extension of the main groove 231, and a straight groove step 235 is formed between the straight groove portion 233 and the main groove 231, so a depth of the straight groove portion 233 may be shallower than a depth of the main groove 231. A branch step 236 is formed at a connecting portion of the branch groove 234 and the V-shaped groove 232, so a depth of the branch groove 234 may be shallower than a depth of the V-shaped groove 232.

An upper end portion of a V-shaped internal wall of the V-shaped groove 232 is formed as a guide mouth 237, and the guide mouth 237 is disposed closer to one side of the branch groove 234, so a width of the V-shaped groove 232 close to the branch groove 234 may be narrower than that of the V-shaped groove 232 close to the straight groove portion 233.

A portion of the straight groove portion 233 close to the V-shaped groove 232 includes a ramp starting point 238. The depth of the straight groove portion 233 gradually becomes shallower from the ramp starting point 238 to the straight groove step 235.

The locking cable 25 is provided in the cable groove of the locking guide plate 23. One end portion of the locking cable 25 is fixedly connected to the locking frame 27, and the locking cable 25 extends from the locking frame 27 and is provided to penetrate through the main groove 231. The other end portion of the locking cable 25 is a free end portion provided with a cable hook 251.

### Unlocking Operation of Headrest

When the button 21 is pressed, the button rod 22 and the locking guide plate 23 move to the left (M1 direction). When the locking guide plate 23 moves to the left, the cable hook 251 moves to the sealed annular groove along the main groove 231. Due to blocking of the straight groove step 235, the cable hook 251 moving to the left may not enter the straight groove portion 233, enter the branch groove 234, and move until finally reaching the V-shaped groove 232 (first path RT1).

When the pressing of the button 21 is stopped, the cable hook 251 is restrained by the V-shaped groove 232 and does not contract, and is thus locked in the V-shaped groove 232. In the instant state, the locking cable 25 pulls the locking guide plate 23 not to return. The locking/unlocking device 2 enters the unlocked state.

The operating rod 3 is connected to the unlocking plate 24 through a buckle structure. When pressing the button 21, the operating rod 3 moves to the left together with the locking guide plate 23, and the operating rod 3 pushes the latch plate 4 to the left, disengaging the latch 43 from the latch groove 91 of the guide rod 9 to implement the unlocking in the up and down direction thereof. In the instant state, since the guide rod sleeve 8 is fixedly connected to the headrest support 1 and the latch plate 4, the headrest, i.e., the position of the operating rod 3 may be adjusted in the up and down direction along the guide rod 9.

When pressing the button 21, the spring seat hole 41 of the latch plate 4 pushes the front and rear locking pin 7 to be disengaged from the pad connecting portion 5, implementing the unlocking in the forward and backward direction thereof. In the instant state, the pad connecting portion 5 may move the headrest in the forward and backward direction with respect to the front and rear guide members 6. Therefore, the position of the headrest may be adjusted in the forward and backward direction

### Locking Operation of Headrest

When the button 21 is pressed again, the locking guide plate 23 moves to the left again. Since the guide mouth 237 is closer to the branch groove 234 and due to interference of the branch step 236, the cable hook 251 may not enter the branch groove 234 and enter the straight groove portion 233. When the pressing of the button 21 is stopped, the locking guide plate 23 returns to an initial position by action of the return spring 26, and the unlocking plate 24 and the operating rod 3 return to the initial state along the locking guide plate 23 to implement the locked state. In the instant case, the cable hook 251 enters the main groove 231 along the straight groove portion 233.

The front and rear locking pin 7 includes the locking pin spring 71. When the operating rod 3 returns to the initial state, the force pushing the latch plate 4 disappears, and the front and rear locking pin 7 moves to the right by the pushing force of the locking pin spring 71 so that the front and rear locking pin 7 is inserted into the pad connecting portion 5, implementing the locking in the forward and backward direction thereof. In the instant state, the pad connecting portion 5 may not move with respect to the front and rear guide member 6, so that the position of the headrest may not be adjusted in the forward and backward direction thereof.

At the same time, the latch plate 4 returns along the unlocking plate 24 so that the latch 43 is inserted into the latch groove 91 of the guide rod 9 again, implementing the locking in the up and down direction thereof. In the instant state, since the guide rod sleeve 8 is fixedly connected to the headrest support 1 and the latch plate 4, the position of the headrest may not be adjusted in the up and down direction thereof.

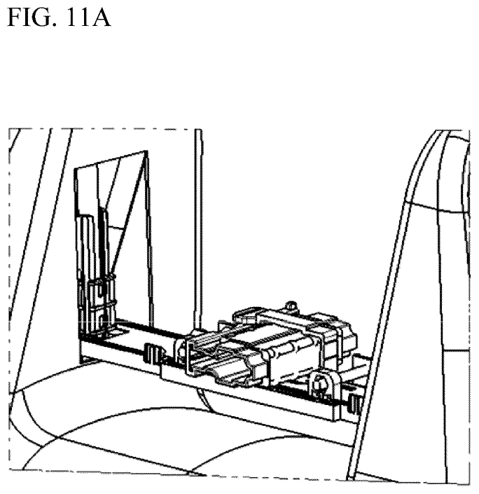

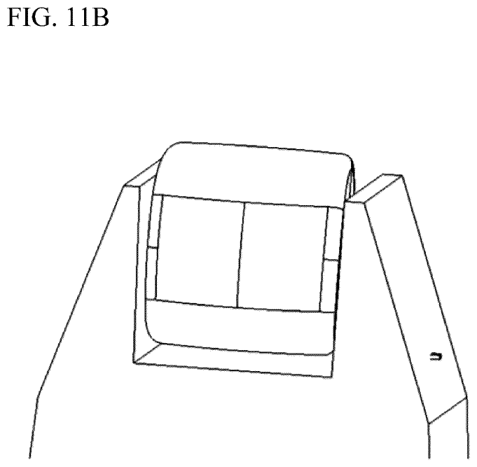

FIG. 11A is a schematic diagram illustrating that the headrest adjustment device according to an exemplary embodiment of the present disclosure is mounted on the seat backrest. FIG. 11B is a schematic diagram illustrating the upper portion of the seat provided with the headrest adjustment device according to an exemplary embodiment of the present disclosure.

As illustrated in FIG. 11A and FIG. 11B, the integral vehicle seat according to an exemplary embodiment of the present disclosure includes the headrest adjustment device, the integral vehicle seat includes a backrest cushion, and the headrest groove is provided on an upper portion of the backrest cushion. The headrest groove is a quadrangle with an upper opening, and the backrest cushion is fixedly disposed on the backrest frame, so that the position of the headrest may be adjusted up, down, forward, or backward in the headrest groove.

To better interpret and precisely define the appended claims, the terms “upper”, “lower”, “inner”, and “outer” are used to describe the features of exemplary embodiments with reference to the positions of these features illustrated in the drawings.

While the present disclosure has been described in connection with what is presently considered to be practical embodiments, it is to be understood that the present disclosure is not limited to the disclosed exemplary embodiments of the present disclosure. On the other hand, it is directed to cover various modifications and equivalent claims as well as various alternatives and modifications thereof. It is intended that the scope of the present disclosure be defined by the Claims appended hereto and their equivalents.”

What is claimed is:

1. A headrest adjustment device for an integral vehicle seat for adjusting a position of a headrest in a forward and backward direction or an up and down direction, the headrest adjustment device comprising:
a headrest support, a pad connecting portion, a front and rear guide member, a guide rod, and a guide rod sleeve,
wherein the headrest support is fixedly disposed on a lower end portion of the headrest, and at least one end portion of the headrest support includes a guide rod through hole,
wherein the pad connecting portion is fixedly disposed on a pad of the headrest;
wherein the front and rear guide member is mounted to the pad connecting portion and guides the pad connecting portion to move in the forward and backward direction,
wherein the guide rod includes a lower end portion fixedly connected to a backrest frame of the vehicle seat,
wherein the guide rod sleeve is sleeved to the guide rod and is movable up or down with respect to the guide rod, and
wherein the guide rod sleeve and the front and rear guide member are fixedly disposed on the headrest support.

2. The headrest adjustment device of claim 1, further comprising:
an operating rod, a latch plate, and a locking/unlocking device,
wherein the operating rod includes first and second legs extending downward and in parallel to each other, and a leg slot extending up and down is disposed on one side of the first leg and one side of the second leg adjacent to each other,
wherein a latch plate hole is disposed on at least one end portion of the latch plate, a latch is disposed on one edge portion of the latch plate hole, and an upper end portion of the operating rod is connected to the other end portion of the latch plate,
wherein the locking/unlocking device includes a button, a locking guide plate, and an unlocking plate fixed to the locking guide plate, and both sides of the unlocking plate are inserted into the leg slot so that the operating rod is movable up or down with respect to the unlocking plate,
wherein the guide rod includes a plurality of latch grooves along a longitudinal direction of the guide rod.

3. The headrest adjustment device of claim 2,
wherein a state in which the latch is engaged and inserted into at least one of the latch grooves is a locked state, and the latch is in an unlocked state when the latch disengages from the at least one latch groove, based on that the button is pressed to one side in the locked state, an unlocking operation is performed, and the locking guide plate moves to the one side and moves the operating rod to push the latch plate to the one side and disengage the latch from the at least one latch groove, and at the same time, the lock guide plate maintains an unlocked position, and
wherein based on that the button is pressed to the one side again, a locking operation is performed and the locking guide plate returns to an initial position in the unlocked state, and the operating rod moves to push the latch plate to the one side and engage and insert the latch into the at least one latch groove.

4. The headrest adjustment device of claim 2, further comprising:
a front and rear locking pin and a locking pin spring,
wherein the front and rear locking pin is connected to the latch plate,
wherein the locking pin spring is disposed between the headrest support and the front and rear locking pin, and
wherein the pad connecting portion includes an engaging groove into which the front and rear locking pin is selectively engaged.

5. The headrest adjustment device of claim 4,
wherein, by performing the unlocking operation, the front and rear locking pin overcomes an elastic force of the locking pin spring and is disengaged from the engaging groove, and by performing the locking operation, the front and rear locking pin is pushed and inserted into the engaging groove of the pad connecting portion by a restoring force of the locking pin spring.

6. The headrest adjustment device of claim 4,
wherein the headrest support further includes a pin spring support body and a base spring groove,
wherein the pin spring support body is disposed to protrude upwards from one end wall of the base spring groove,
wherein the latch plate includes a spring seat hole, and the spring seat hole is aligned with the base spring groove,
wherein the pin spring support body is in contact with a first end wall of the spring seat hole, and
wherein the front and rear locking pin further includes a locking pin projection protruding downward, the locking pin projection is in contact with a second end wall of the spring seat hole, and the locking pin spring is disposed between the pin spring support body and the locking pin projection.

7. The headrest adjustment device of claim 6, further comprising:
a second locking pin spring,
wherein the headrest support further includes a second pin spring support body and a second base spring groove, and
wherein the second pin spring support body is disposed to protrude upwards from one end wall of the second base spring groove, the latch plate includes a second spring seat hole, the second spring seat hole is aligned with the second base spring groove, the second pin spring support body is in contact with a first end wall of the second spring seat hole, and the second locking pin spring is disposed between the second pin spring support body and a second end wall of the second spring seat hole.

8. The headrest adjustment device of claim 2,
wherein the locking/unlocking device further includes a button rod, a locking cable, a return spring, and a locking frame,
wherein the locking frame is fixed to a seat backrest frame, a first end portion of the return spring is connected to the locking guide plate and a second end portion thereof is connected to the locking frame, the button is connected to the locking guide plate through the button rod, the locking guide plate includes a cable groove, the locking cable extends within the cable groove, a first end portion of the locking cable is fixed to the locking frame, and a second end portion of the locking cable includes a cable hook,
wherein the cable groove includes a main groove and a sealed annular groove, a first end portion of the sealed annular groove is a connecting end portion communicating with the main groove, a second end portion thereof is formed as a V-shaped groove, and a V-shaped upper end portion of the V-shaped groove faces the main groove.

9. The headrest adjustment device of claim 8,
wherein based on that the button is pressed, the locking guide plate moves so that the cable hook enters the V-shaped groove from the main groove and is fixed, based on that the button is pressed again, the cable hook is disengaged from the V-shaped groove and returns to the main groove, and the locking guide plate returns to an initial position by action of the return spring.

10. The headrest adjustment device of claim 8, wherein the sealed annular groove further includes a straight groove portion and a branch groove, the straight groove portion extends from an end portion of the main groove to a first end portion of the V-shaped groove, the branch groove branches from a connection point between the straight groove portion and the main groove and extends to a second end portion of the V-shaped groove, an end portion of a V-shaped internal wall of the V-shaped groove is formed as a guide mouth, and the guide mouth is disposed closer to the branch groove, so that a width of one side of the branch groove of the V-shaped groove is smaller than a width of one side of the straight groove portion.

11. The headrest adjustment device of claim 8, wherein the connecting end portion of the sealed annular groove is connected to a first end portion of the V-shaped groove through a straight groove portion and to a second end portion of the V-shaped groove through a branch groove, and a straight groove step is formed between the straight groove portion and the main groove so that a depth of the straight groove portion is shallower than a depth of the main groove, and a branch step is formed at a connecting portion of the branch groove and the V-shaped groove so that a depth of the branch groove is shallower than a depth of the V-shaped groove.

12. The headrest adjustment device of claim 11, wherein the straight groove portion includes a ramp starting point at a portion close to the V-shaped groove, and the depth of the straight groove portion becomes shallower from the ramp starting point to the straight groove step.

13. The headrest adjustment device of claim 1, wherein a rolling bearing is disposed on an internal surface of the front and rear guide member for guiding the pad connecting portion in the front and rear guide member.

14. An integral vehicle seat comprising the headrest adjustment device for the integral vehicle seat of claim 1, wherein the integral vehicle seat further includes a backrest cushion, a headrest groove is provided on an upper portion of the backrest cushion, an opening is provided on an upper portion of the headrest groove, the backrest cushion is fixedly disposed on a backrest frame, and the headrest is positioned within the headrest groove.

15. A vehicle comprising the headrest adjustment device of claim 1.
